(19) United States
(12) Patent Application Publication
(10) Pub. No.: US 2008/0259720 A1
(43) Pub. Date: Oct. 23, 2008

(54) Methods and Apparatus for Microfluidic Mixing

(76) Inventors: Yee Cheong Lam, Singapore (SG); Hiong Yap Gan, Singapore (SG); Nam Trung Nguyen, Singapore (SG); Chun Yang, Singapore (SG); Kam Chiu Tam, Ontario (CA)

Correspondence Address: WINSTON & STRAWN LLP;PATENT DEPARTMENT, 1700 K STREET, N.W., WASHINGTON, DC, 20006, US

(21) Appl. No.: 11/995,477

(22) PCT Filed: May 19, 2006
(86) PCT No.: PCT/SG06/00130

§ 371 Date: Jun. 25, 2008

Related U.S. Application Data
(60) Provisional application No. 60/701,078, filed on Jul. 21, 2005.

(51) Int. Cl. B01F 5/00; B01F 3/08

(52) U.S. Cl. 366/150.1

(57) ABSTRACT

An apparatus for microfluidic mixing having a first fluid inlet for a first fluid operatively connected to a first fluid channel. A second fluid inlet is provided for a second fluid operatively connected to a second fluid channel. The second fluid channel operatively intersects the first fluid channel for introduction of the second fluid into the first fluid channel. The first fluid channel has an outlet end remote from that of the first fluid inlet, and at least one contraction intermediate the intersection of the first fluid channel with the second fluid channel and the at least one outlet end, or intermediate the first fluid inlet and the intersection of the first fluid channel with the second fluid channel. A corresponding method is also disclosed.

### FIELD OF THE INVENTION

This invention relates to methods and apparatus for microfluidic mixing and refers particularly, though not exclusively, to such methods and apparatus based on instability caused by viscoelastic behavior of fluids.

### DEFINITION

Throughout this specification a reference to microfluidic mixing is to be taken as including mixing at micro-length scale as well as smaller length scales and larger length scales.

### BACKGROUND OF THE INVENTION

Microfluidic devices and methods have enabled technologies for analytical chemistry and biochemical analysis. In general, analysis processes are carried out at the micro length scale. Because of the larger surface-to-volume ratio, flow in microstructures is laminar and stable. Since mixing is a key process for all chemical processes or most microfluidic applications, effective and fast mixing under laminar conditions is required. A number of micromixer designs have been proposed.

Generally, micromixers can be categorized as being either passive or active. Active micromixers require actuators and involve moving parts. As such, they are not attractive for disposable applications. Passive micromixers have no actuators and no moving parts. Passive mixing concepts rely on molecular diffusion or chaotic advection. Passive mixers based on molecular diffusion utilize concepts such as parallel lamination, serial lamination, and serial segmentation to reduce mixing time and to shorten mixing paths in microchannels.

Passive mixers based on chaotic advection use instabilities caused by geometrical modifications at medium and high Peclet numbers: Pe= V̅L_{char}/D, where V̅, L_{char} and D are the mean velocity, characteristic mixing path, and molecular diffusion coefficient, respectively. Practically, passive mixers still require long and complicated channel structures, which result in complex and expensive fabrication processes. Thus, they are not attractive for practical applications.

For viscous fluid flow, inertial and viscous forces are relevant and are typified by the Reynolds number: Re=ρ V̅d/ηₒ, where d, ρ and ηₒ are the characteristic length, the fluid density and dynamic viscosity, respectively. Microchannels have small characteristic dimension, and thus a low Re. Generally, this results in stable and laminar flow, and difficulty in mixing.

It is well known that the elasticity of a viscoelastic fluid can introduce elastic stress in addition to viscous stress. The stress experienced by a viscoelastic fluid will not immediately become zero with the cessation of fluid motion and driving forces, but will decay with a characteristic time due to its elasticity. An example of a viscoelastic fluid is a fluid with dilute (i.e. a minute amount of) deformable and high molecular weight polymers. Viscoelastic instability of these non-Newtonian fluids is known.

In general, a viscoelastic fluid with larger and/or higher concentrations of polymer molecules has a longer relaxation time, while a smaller channel has a shorter flow characteristic time. For a viscoelastic fluid flow in a given micro geometry, as the dimensions of a channel decrease, the Re becomes smaller and it is more difficult to have inertia/viscous flow instability; but the Deborah number (De=characteristic relaxation time/flow characteristics time or elastic forces/viscous forces) becomes larger and it is easier to have elastic/viscous instability. Hence, for viscoelastic fluid flows in microchannels, the inertial effects are negligible, and the flow is dominated by viscoelastic forces.

For microfluidics, it is common to have a Reynolds number in the order of unity and a laminar flow is expected for Newtonian fluids and fluids with negligible elasticity.

Microfluidic devices are the key to micro-scale analytical chemistry and biochemical analysis. With large surface to volume ratio and small characteristic length, flow field in microchannels is normally laminar and stable. Without employing viscoelastic fluids, the mixing of two or more streams is normally only able to be achieved by diffusion, and not by the more effective mechanism of flow instability and/or turbulence. However, diffusive mixing will compromise the requirements of short mixing path and time for efficient mixing.

### SUMMARY OF THE INVENTION

In accordance with a first preferred aspect there is provided apparatus for microfluidic mixing that has at least one first fluid inlet for a first fluid, the at least one first fluid inlet being operatively connected to a first fluid channel. At least one second fluid inlet is provided for at least one second fluid operatively, the at least one second fluid inlet being operatively connected to a second fluid channel. The at least one second fluid channel operatively intersects the first fluid channel for introduction of the second fluid into the first fluid channel. The first fluid channel has at least one outlet end remote from the at least one first fluid inlet. There is at least one contraction in the first fluid channel in at least one location selected from: intermediate the intersection of the first fluid channel with the at least one second fluid channel and the outlet end, and intermediate the at least one first fluid inlet and the intersection of the first fluid channel with the at least one second fluid channel.

According to a second preferred aspect there is provided a method for microfluidic mixing. The method comprises supplying a first fluid to at least one first fluid inlet for flow along a first fluid channel, the first fluid channel having at least one outlet end remote from the at least one first fluid inlet and at least one contraction in the first fluid channel in at least one location selected from: intermediate the intersection with at least one second fluid channel and the outlet end, and intermediate the at least one first fluid inlet and the intersection with the at least one second fluid channel. At least one second fluid is supplied to at least one second fluid inlet for flow along the at least one second fluid channel, the at least one second fluid channel operatively intersecting the first fluid channel for introduction of the at least one second fluid into the first fluid channel for a first stage of mixing of the first fluid and the at least one second fluid. The first fluid and the at least one second fluid are then passed through the contraction for a second stage of mixing of the first fluid and the at least one second fluid.

For both aspects the at least one second fluid channel may comprise two channels, one on each side of the first fluid channel. The two channels may be identical, or non-identical. The two channels may intersect the first fluid channel at the same or different locations along the first fluid channel. The at least one contraction may be an abrupt contraction/expansion and may have a ratio of x:y:z, with x and z greater than y. The ratio may be determined by a flow rate of the mixed first fluid and at the least one second fluid, a viscosity of the mixed first fluid and at the least one second fluid, an elasticity of the mixed first fluid and at the least one second fluid, and to reduce dead volume. The first fluid inlet, first fluid channel, second fluid inlet, second fluid channel, and the outlet end may be formed in an upper portion of a substrate. A lower portion of the substrate may close the first fluid inlet, first fluid channel, second fluid inlet, second fluid channel and the outlet end. The first channel may comprise an upstream portion upstream of the contraction, and a downstream portion downstream of the contraction; the first stage mixing being by viscoelastic instability taking place in the upstream portion, and the second stage mixing being by viscoelastic flow instability and expansive flow taking place in the downstream portion.

### BRIEF DESCRIPTION OF THE DRAWINGS

In order that the present invention may be fully understood and readily put into practical effect, there shall now be described by way of non-limitative example only preferred embodiments of the present invention, the description being with reference to the accompanying illustrative drawings.

In the drawings:

FIG. 1 is a schematic plan view of a first preferred embodiment;

FIG. 2 is a schematic cross-sectional view along the lines and in the direction of arrows A-A on FIG. 1;

FIG. 3 is a schematic cross-sectional view along the lines and in the direction of arrows B-B on FIG. 1;

FIG. 4 illustrates viscoelastic instability at a first flow rate:

FIG. 5 illustrates viscoelastic instability at a second flow rate;

FIG. 6 is a reproduction of experimental results at the first flow rate; and

FIG. 7 is a reproduction of experimental results at the second flow rate.

### DETAILED DESCRIPTION OF THE PREFERRED EMBODIMENTS

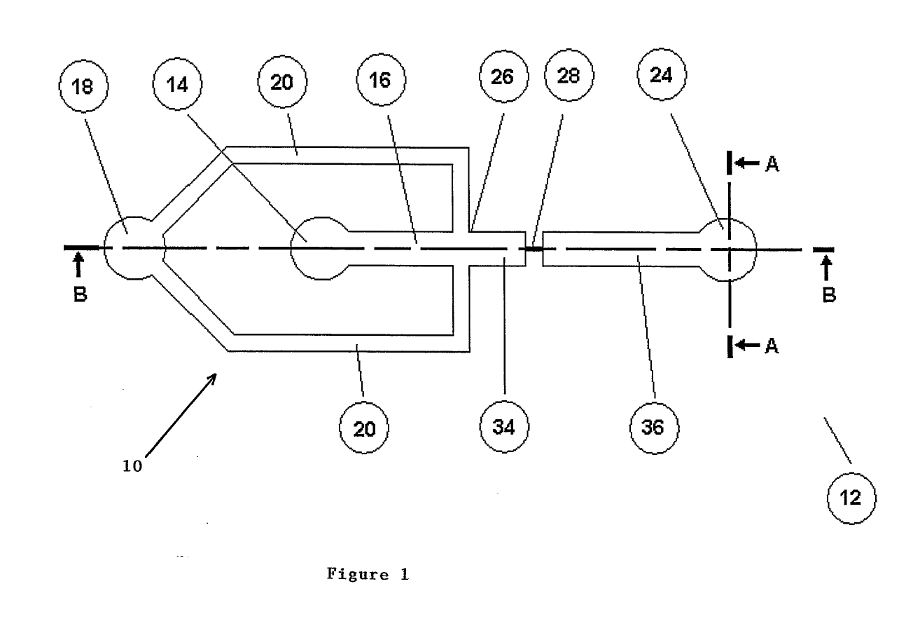

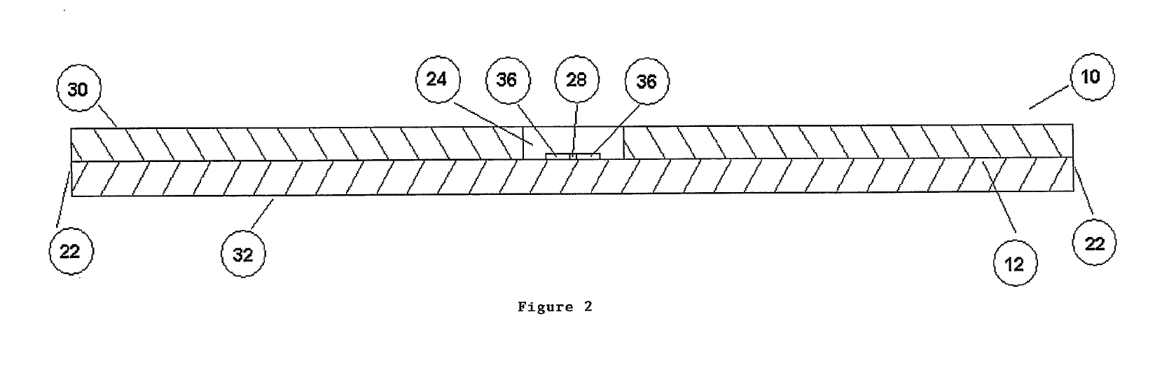

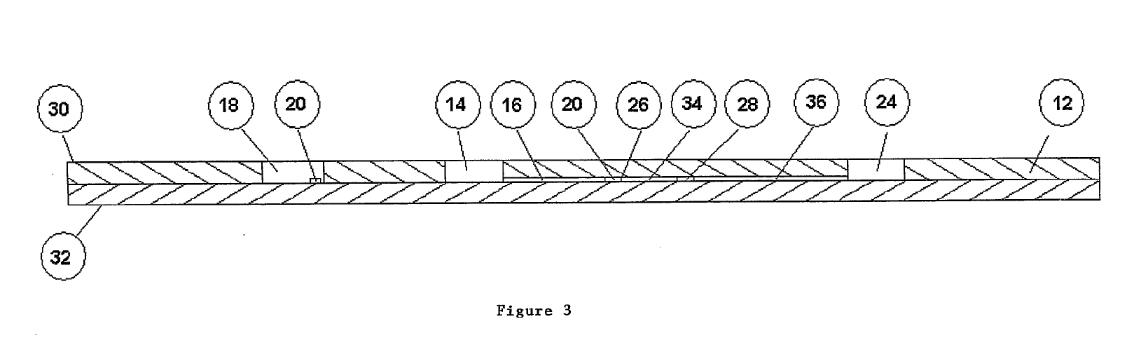

FIGS. 1 to 5 show a first embodiment. It is a microfluidics mixing apparatus 10 for mixing at least two fluids. It has a substrate 12 in which are formed a first fluid inlet well 14 operatively connected to a first fluid channel 16. A first fluid is able to be introduced into the first fluid well 14 and passes along first fluid channel 16. There is also a second fluid inlet well 18 operatively connected to at least one second fluid channel 20. In this case, there are two second fluid channels 20 that are a mirror image of each other. The two second fluid channels 20 may be identical, if desired or required. Alternatively, they may be different. Each channel 20 is located between the first channel 16 and an edge 22 of the substrate 12. They may be on either side of first channel 16 (as shown) or the one side. Each second channel 20 intersects the first channel 16 at an intersection 26. The two second channels 20 may intersect the first channel at the one location 26 (as shown) or at different locations. At the intersection 26 the second fluid enters the first fluid channel 16.

Each second channel 20 may have its own inlet well 18 so that the fluids can be different. In this way there would be three fluid inlets and channels, for three different fluids. The fluids may be input at different times, and at different flow rates.

The first fluid channel 16 has at least one outlet well 24 at its end. The outlet well 24 may be centered in the substrate 12 or may be located on the periphery of the substrate 12. The outlet well 24 may connect to a second fluid handling device (not shown), and the second fluid handling device may be a duplication of the apparatus 10, or may be a different device. The bottom layer 32 may be transparent to allow optical access. The channels 16, 20 may have a cross-section shape that is rectangular, circular, oval, or trapezoidal, or otherwise as required or desired. The first channel 16 may be larger in cross-sectional area than each of the second channels 20. Alternatively, the first channel 16 may be similar in cross-sectional area as each of the second channels 20. Further alternatively, the first channel 16 may be smaller in cross-sectional area than each of the second channels 20.

The substrate 12 has a top layer 30 and a bottom layer 32 which is generally parallel to the top layer 30. The channels 16, 20 and wells 14, 18, 24 are fabricated onto the top layer 30, and are sealed by the bottom layer 32, which is generally flat. The wells 14, 18, 24 and part of the channels 16, 20 may be located on the bottom layer 32 if desired or required. The substrate 12 may be of any suitable material such as, for example, polymer, silicon, metal, glass, ceramic, or any combination of them.

Intermediate the outlet well 24 and intersection 26 is a contraction 28. The contraction 28 is preferably an abrupt contraction/expansion which may have a ratio of x:y:z, with x and z greater than y. More preferably is at a ratio of at least 4:1:4. Alternatively or additionally, the contraction 28 in the first fluid channel 16 may be intermediate the first fluid inlet 14 and the intersection 26. There may be more than one contraction. If there are more than one, they may be the same or different. They may be located intermediate the intersection 26 and the outlet well 24 and intermediate the first fluid inlet 14 and the intersection 26.

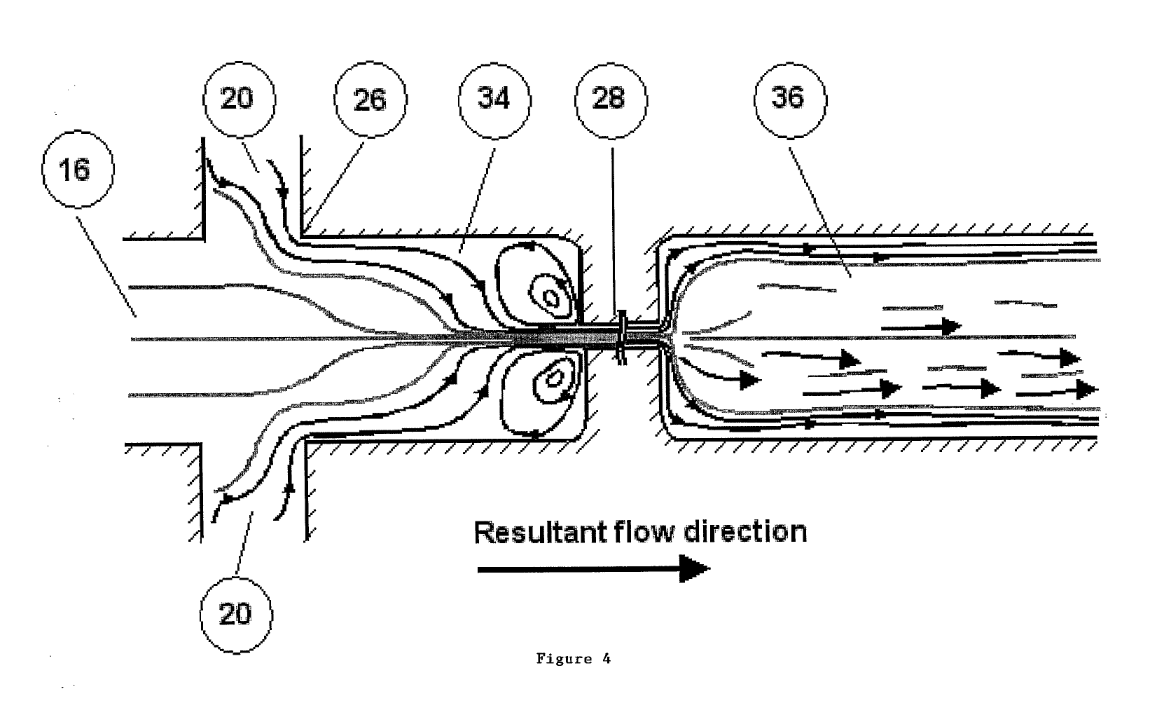

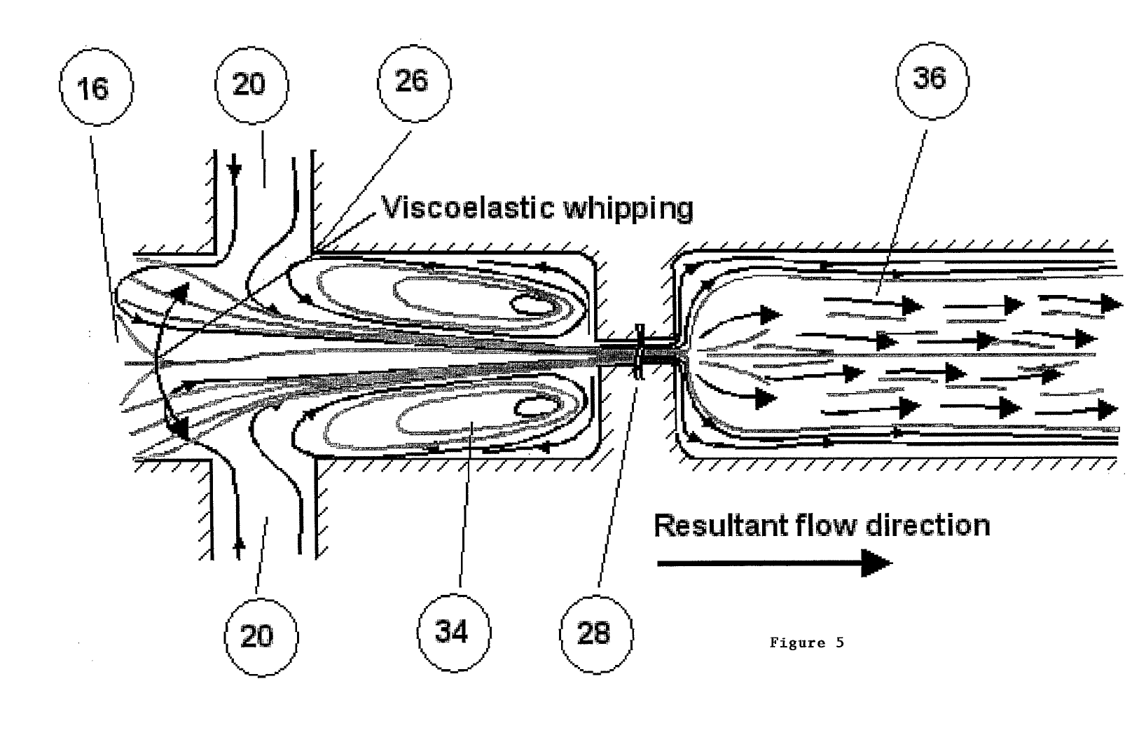

As shown in FIGS. 4 and 5, at intersection 26, the two fluids join in the first channel 16 then flow through the abrupt contraction 28. The mixing section of the first channel 16 may be classified as an upstream portion 34 and downstream portion 36. The upstream portion 34 is upstream of the contraction 28, and the downstream portion 36 is downstream of the contraction 28. The upstream portion 34 routes the fluids to be mixed from a periphery of the channel to the center of the first channel 16 by utilizing viscoelastic instability. Thereafter, the upstream portion 34 feeds the fluids to the downstream portion 36, wherein the fluids are further mixed in a fully viscoelastic instability flow pattern when exiting the contraction 28 and experiencing expansive flow effects.

The contraction/expansion ratio, a ratio of x:y:z, with x and z greater than y, is determined by:
i) the flow rate of the individual fluids and the mixed fluid;
ii) the viscosity of the individual fluids and the mixed fluid;
iii) the elasticity of the individual fluids and the mixed fluid;
iv) the aim of keeping the dead volume as low as possible.

The contraction ratio (x:y:z) should have x and z greater than y. The ratio used for FIGS. 4 to 7 was 8:1:8.

The chaotic velocity profile across the section of the channel 16 in both the upstream portion 34 and downstream portion 36 arises from the combination of viscous forces and elastic forces. The viscoelastic forces give rise to the secondary corner vortices and viscoelastic whipping in the upstream portion 34, and result in a first stage mixing. This irregular flow pattern causes flow fluctuation of the main stream through the contraction 28, and fluctuation of flow resistance to the two side streams in second channel 20. The whipping of the main stream facilitates the side streams penetrating deeply into the central flow in the downstream portion 36. These fluctuations result in viscoelastic flow instability downstream of the contraction 38. This viscoelastically induced flow instability together with the sudden expansive flow in the downstream portion 36, promotes effective and efficient mixing.

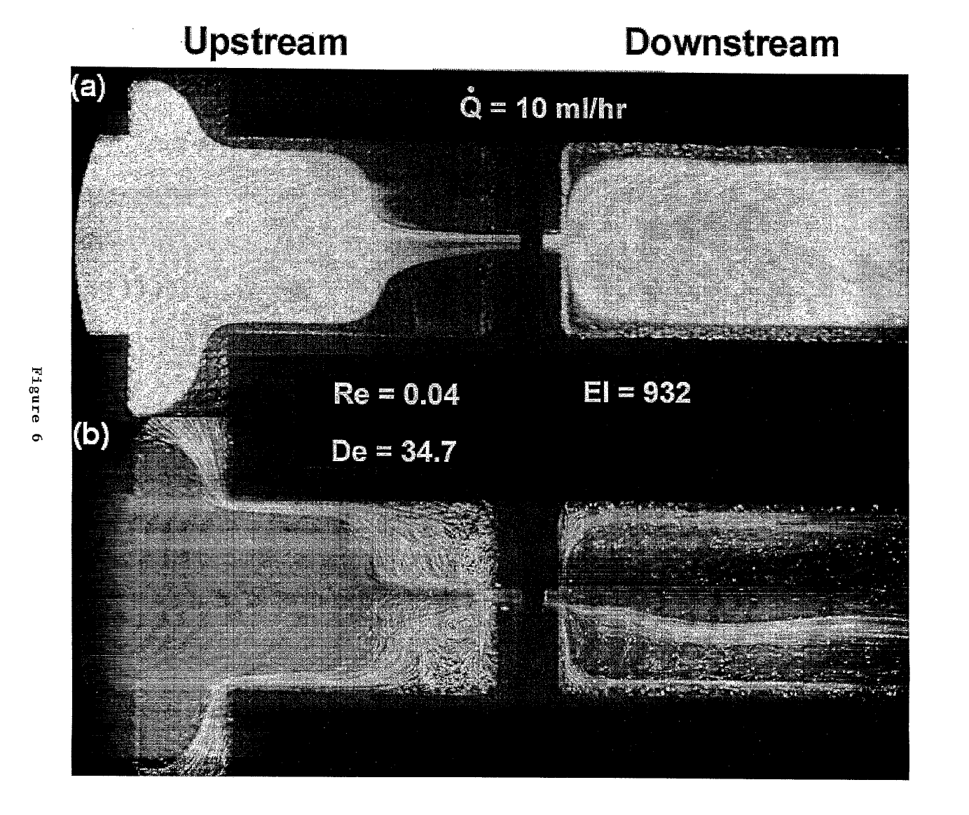

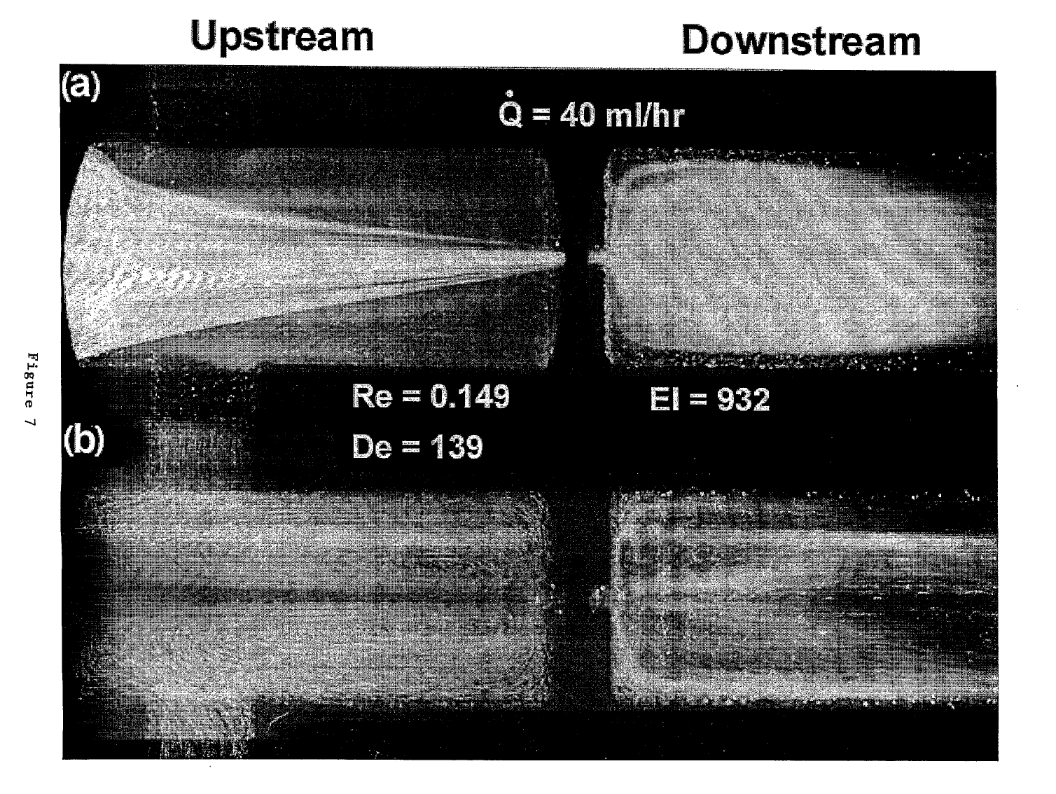

In the examples of FIGS. 6 and 7, a microchannel of 200 μm in depth with an abrupt contraction of 1600 μm: 200 μm: 1600 μm was used to introduce convergent/divergent flows. The length of the contraction was 800 μm. Side streams 20 were introduced into the central main stream 16 through two side channels 20, on either side of the main channel 16. The side channels 20 were 800 μm in width, and 3400 μm upstream from the centerline of the contraction 28. The apparatus was fabricated using two 1 mm thick polymethylmethacrylate (PMMA) layers, with the channels 16, 20 being machined by CO₂ laser onto the top layer 30, and sealed by the bottom layer 32. The wells 14, 18 and 24 were fabricated on top layer 30 (not shown) or alternatively on bottom layer 32 (not shown).

The mixing was of two dissimilar fluids. The main stream in first channel 16 was 1 wt % polyethyleneoxide (PEO) in 55 wt % glycerol water (1% PGW for brevity). This has a high viscosity and elasticity. The side streams were 0.1 wt % PEO in water (0.1% PW for brevity). They entered the main microchannel 16 through the two side channels 20. The molecular weight (M_{w}) of PEO employed was approximately 2×10⁶ g/mol. For image acquisition of the flow fields, a fluorescent dye (fluorescein disodium salt C₂₀H₁₀Na₂O₅) was added to 1% PGW at a weight ratio of 4×10⁻⁴:1 to identify the main stream. For the side streams, 3 μm red fluorescent microsphere solution (Duke Scientific Co.) was added to 0.1% PW at a volume ratio of 0.03:1. The addition of fluorescent dye and microspheres has negligible effects on the fluid properties, and the fluid properties were determined with the additives. For each flow rate, flow field images in the same experiment identified by green fluorescent dye (main stream) or red fluorescent microsphere solution (side stream) were captured at different time by changing the filtering lens.

The total volumetric flowrate is \dot{Q}, with the mainstream flowrate being 0.5 \dot{Q}, and each of the side streams flowrate being 0.25\dot{Q}. The \dot{Q} investigated were 10, 20 and 40 ml/hr. The sample fluids were primed into the microchannels by driving the syringes, with appropriate size ratio, using the same micro-syringe pump.

Table 1 contains the rheological properties of the fluids. Relaxation time (λ) were measured from the frequency oscillation test and the steady shear viscosities were determined using amplitude sweep test at shear rates 0.01≦\dot{γ}≦1000 s⁻¹. The De, Re and Pe are estimated as: De=λ\dot{γ}_{char} where the characteristic shear rate is \dot{γ}_{char}= V̅/w_{c}/2, λ is the relaxation time of the viscoelastic fluid measured in shear, V̅ is the average flow velocity, d is the channel depth and w_{c} is the contraction width. Re=ρ V̅Dₕ/ηₒ, where ρ, Dₕ, and ηₒ are the fluid density, the hydraulic diameter, and the viscosity respectively. The Peclet number is estimated as Pe= V̅L_{char}/D, where L_{char} is the upstream channel width and D is the diffusion coefficient. The average velocity in term of total volumetric flowrate is estimated as V̅=\dot{Q}/w_{c}d, where Q̅ is the total flowrate of the device.

The diffusion coefficient in dye/water solution was determined as D=1.5×10⁻⁹ m²/s. Since the diffusion coefficient is inversely proportional to viscosity, D=3.55×10⁻¹² m²/s approximately for 1% PGW. As such, 1% PGW at \dot{Q}=40 ml/hr, the dimensionless parameters are Pe=125×10⁶, Re=0.149, De=139 approximately.

TABLE 1

| | Zero-shear | | |
|---|---|---|---|
| | viscosity, | Density, | Relaxation time, |
| Fluid | ηₒ (Pa.s) | ρ (kg/m³) | λ (s) |
| Water | 1 × 10⁻³ | 1.00 × 10³ | — |
| 26% GW with | 1.79 × 10⁻³ | 1.06 × 10³ | — |
| micro-particle | | | |
| 96% GW with | 424 × 10⁻³ | 1.24 × 10³ | — |
| fluorescence dye | | | |
| 0.1% PW with | 1.79 × 10⁻³ | 0.997 × 10³ | 1.5 × 10⁻³ |
| micro-particle | | | |
| 1% PGW with | 423 × 10⁻³ | 1.13 × 10³ | 50 × 10⁻³ |
| fluorescence dye | | | |

FIGS. 6 and 7 show the flow fields for \dot{Q}=10 ml/hr (Re=0.037, De=34.7) and \dot{Q}=40 ml/hr (Re=0.149, De=139). Upstream of the contraction 28, at \dot{Q}=10 ml/hr, the flow field as shown in FIGS. 6(a)-(b) were rather stable. However, the interface between the streams was ill defined, with a lower level of fluorescent intensity near the interface, indicating mixing. With increasing flow rate, e.g. at \dot{Q}=40 ml/hr, salient and large corner vortices were formed, see FIGS. 7(a) and (b). “Whipping” or swinging repeatedly of the fluorescent central main stream across the channel width was observed. Through whipping, the mainstream “encapsulated” the side stream fluid and swung together continuously as the flow was progressing. Moreover, when the flow approached the contraction entrance, more and more fluorescent creeks (initially within the central main stream) were directed to the sides instead of flowing through the contraction. These diverted “creeks” were then circulated within the vortex (swirling stream) and then blended back into the central main stream. Competition between the main and the side streams was taking place at the entrance region next to the contraction. This competition becomes frantic with an increasing flowrate, and the entire flow field became unstable. Significant overlapping between the main and the side streams (comparing FIGS. 7(a) and 7(b)), and lower level of fluorescent intensity at the proximity of the “swinging” mainstream indicated mixing. The occurrence of upstream mixing and whipping of the main stream is depicted pictorially in FIGS. 4 and 5.

Downstream of the contraction, subsequent to the main and the side streams competing and gushing through the contraction at high speed, the viscoelastic flow instability was more significant. At \dot{Q}=10 ml/hr, there was some penetration of the side stream fluid into the central portion of the channel, overlapping with the main stream fluid, see FIG. 6(b). This penetrated-stream fluctuated in location and was intermittent, indicating flow instability. FIG. 6(a) shows the expansion flow for the main stream immediate downstream of the contraction. The main and the side streams overlapped (comparing FIGS. 6(a) and 6(b)) indicating mixing, but it was yet to extend comprehensively across the whole channel width. At \dot{Q}=40 ml/hr, as discussed previously, the mainstream exhibited significant viscoelastic whipping at upstream. This caused flow fluctuation and resistance through the contraction. Indeed, this whipping facilitated the side streams penetrating deeply into the central portion downstream, see FIG. 7(a). These fluctuations also resulted in flow instability downstream of the contraction. This flow instability with the expansion-flow of the main stream promoted effective mixing. Other than a thin boundary layer, FIGS. 7(a) and (b) show comprehensive mixing over the entire cross-section. These phenomena are depicted pictorially in FIGS. 4 and 5.

To study the necessity of fluid elasticity for flow instability and mixing, viscous fluids devoid of elastic effects were employed, namely 96% and 26% glycerol/water solutions were employed in the main and side streams respectively, The viscosity ratio is approximately the same as for the viscoelastic flows, see Table 1. The entire flow field was stable for all the flowrates investigated, for example for \dot{Q}=40 ml/hr (Re=0.16, De≈0), see FIG. 8(a). The interface between the streams was smooth, stable and well defined, with no mixing between the streams. This indicated that fluid viscosity alone was insufficient, and fluid elasticity was essential for flow instability.

In FIG. 8(b), water was employed for both streams at \dot{Q}=40 ml/hr. (highest Re=55.5 with De≈0). It has negligible elasticity and low viscosity, and thus inertia plays a relatively larger role. At upstream, the interface between the streams was well defined and stable. A pair of symmetrical corner vortices (lip vortices) were formed immediately downstream of the contraction due to sudden expansion. There was some spread of the main stream into the side streams, but no penetration of the side streams into the main stream. This indicated mixing, although insignificant, at downstream due to inertial/viscous effects.

Whilst there has been described in the foregoing description preferred embodiments of the present invention, it will be understood by those skilled in the technology concerned that many variations or modifications in details of design or construction may be made without departing from the present invention.

1-27. (canceled)

28. An apparatus for microfluidic mixing comprising:
at least one first fluid inlet for a first fluid, the at least one first fluid inlet being operatively connected to a first fluid channel;
at least one second fluid inlet for at least one second fluid, the at ′” least one second fluid inlet being operatively connected to at least one second fluid channel, with the at least one second fluid channel operatively intersecting the first fluid channel for introduction of the second fluid into the first fluid channel;
at least one outlet end of the first fluid channel remote from the at least one first fluid inlet; and
at least one contraction in the first fluid channel in at least one location selected from the group consisting of: intermediate the intersection of the at least one second fluid channel with the first fluid channel and the at least one outlet end, and intermediate the at least one first fluid inlet and the intersection of the first fluid channel with the at least one second fluid channel.

29. The apparatus of claim 28, wherein the at least one second fluid channel comprises two channels, one on each side of the first fluid channel.

30. The apparatus of claim 29, wherein the two channels are identical.

31. The apparatus of claim 29, wherein the two channels are not identical.

32. The apparatus of claim 29, wherein the two channels intersect the first fluid channel at the same position on the first fluid channel.

33. The apparatus of claim 29, wherein the two channels intersect the first fluid channel at different positions on the first fluid channel.

34. The apparatus of claim 28, wherein the contraction is an abrupt contraction/expansion.

35. The apparatus of claim 34, wherein the contraction has a ratio x:y:z where x and z are both greater than y.

36. The apparatus of claim 35, wherein the ratio is at least 4:1:4.

37. The apparatus of claim 35, wherein the ratio is determined by a flow rate of the first and second fluids, a viscosity of the first and second fluids, an elasticity of the first and second fluids, and to reduce dead volume.

38. The apparatus of claim 28, wherein the first fluid inlet, first fluid channel, second fluid inlet, second fluid channel, and the outlet end are formed in an upper portion of a substrate.

39. The apparatus of claim 28, wherein the first fluid inlet, second fluid inlet and the outlet end are formed in a lower portion of a substrate.

40. The apparatus of claim 39, wherein a lower portion of the substrate closes the first fluid inlet, first fluid channel, second fluid inlet, second fluid channel and the outlet end.

41. The apparatus of claim, wherein the first channel comprises an upstream portion upstream of the contraction, and a downstream portion downstream of the contraction; the upstream portion being for a first stage mixing by viscoelastic instability, and the downstream portion being for a second stage mixing by the viscoelasticity instability and expansive flow.

42. A method for microfluidic mixing comprising:
supplying a first fluid to at least one first fluid inlet for flow along a first fluid channel, the first fluid channel having at least one outlet end remote from the at least one first fluid inlet, and at least one contraction in the first fluid channel in at least one location selected from the group consisting of: intermediate the intersection of the first fluid channel with the at least one second fluid channel and the at least one outlet end, and intermediate the at least one first fluid inlet and the intersection of the first fluid channel with the at least one second fluid channel;
supplying at least one second fluid to at least one second fluid inlet for flow along the at least one second fluid channel, the at least one second fluid channel operatively intersecting the first fluid channel for introduction of the at least one second fluid into the first fluid channel for a first stage of mixing of the first fluid and the at least one second fluid; and
passing the first fluid and the at least one second fluid through the at least one contraction for a second stage of mixing of the first fluid and the at least one second fluid.

43. The method of claim 42, wherein the second fluid channel comprises two channels, one on each side of the first fluid channel.

44. The method of claim 43, wherein the two channels are identical.

45. The method of claim 43, wherein the two channels are not identical.

46. The method of claim 43, wherein the two channels intersect the first fluid channel at the same position along the first fluid channel.

47. The method of claim 43, wherein the two channels intersect the first fluid channel at different positions along the first fluid channel.

48. The method of claim 42, wherein the contraction is an abrupt contraction/expansion having a ratio x:y:z where x and z are both greater than y.

49. The method of claim 48, wherein the ratio is at least 4:1:4.

50. The method of claim 48, wherein the ratio is determined by a flow rate of the first fluid and at the least one second fluid, a viscosity of the first fluid and at the least one second fluid, an elasticity of the first fluid and at the least one second fluid, and to reduce dead volume.

51. The method of claim 42, wherein the first fluid inlet, first fluid channel, second fluid inlet, second fluid channel, and the outlet end are in an upper portion of a substrate.

52. The method of claim 42, wherein the first fluid inlet, second fluid inlet, and the outlet end are in a lower portion of a substrate.

53. The method of claim 51, wherein a lower portion of the substrate closes the first fluid inlet, first fluid channel, second fluid inlet, second fluid channel and the outlet end.

54. The method of claim 42, wherein the first channel comprises an upstream portion upstream of the contraction, and a downstream portion downstream of the contraction; the first stage mixing being by viscoelastic instability taking place in the upstream portion, and the second stage mixing being by chaotic instability and expansive flow taking place in the downstream portion.
